(19) United States
(12) Patent Application Publication
(10) Pub. No.: US 2015/0062902 A1
(43) Pub. Date: Mar. 5, 2015

(54) ROTATABLE DUAL BEAM LIGHTING APPARATUS

(71) Applicant: AMERICAN DJ SUPPLY, INC., Los Angeles, CA (US)

(72) Inventor: Toby Velazquez, Yorba Linda, CA (US)

(73) Assignee: AMERICAN DJ SUPPLY, INC., Los Angeles, CA (US)

(21) Appl. No.: 14/014,235

(22) Filed: Aug. 29, 2013

(51) Int. Cl. F21V 21/14

(52) U.S. Cl. CPC F21V 21/14
USPC 362/249.07

(57) ABSTRACT

One embodiment provides a lighting apparatus comprising multiple individually rotatable lighting components, an actuator for rotating one or more of the lighting components, and a control unit for controlling the actuator and the lighting components. Each lighting component comprises one or more lighting elements. The control unit is configured to operate each lighting component independently.

### BACKGROUND

The present invention relates generally to a lighting apparatus, and in particular, to a rotatable dual beam lighting apparatus.

Lighting apparatuses are used for illuminating both indoor and outdoor environments. Proper illumination is vital when filming movies, television shows, shooting videos, taking photographs, lighting live stage performances, and other similar activities.

### BRIEF SUMMARY

One embodiment provides a lighting apparatus comprising multiple individually rotatable lighting components, an actuator for rotating one or more of the lighting components, and a control unit for controlling the actuator and the lighting components. Each lighting component comprises one or more lighting elements. The control unit is configured to operate each lighting component independently.

Another embodiment provides a lighting system comprising multiple lighting apparatuses and a controller for selectively providing data control signals to at least one of the lighting apparatuses. Each lighting apparatus comprises multiple individually rotatable lighting components, an actuator for rotating one or more of the lighting components, and a control unit for controlling the actuator and the lighting components based on data control signals. Each lighting component comprises one or more lighting elements. Each control unit of each lighting apparatus is configured to operate each lighting component of the lighting apparatus independently.

Another embodiment provides a method comprising providing data control signals to a lighting apparatus, and controlling the lighting apparatus based on the data control signals. The lighting apparatus comprises multiple individually rotatable lighting components, an actuator for rotating one or more of the lighting components, and a control unit for controlling the actuator and the lighting components based on the data control signals. Each lighting component comprises one or more lighting elements. The control unit is configured to operate each lighting component independently.

These and other features, aspects and advantages of the present invention will become understood with reference to the following description, appended claims and accompanying figures.

### BRIEF DESCRIPTION OF THE SEVERAL VIEWS OF THE DRAWINGS

FIG. 1 illustrates a front perspective view of a rotatable dual beam lighting apparatus, in accordance with an embodiment of the invention.

FIG. 2 illustrates a rear perspective view of the lighting apparatus in FIG. 1, in accordance with an embodiment of the invention.

FIG. 3 is a block diagram illustrating components of the lighting apparatus in FIG. 1, in accordance with an embodiment of the invention.

FIG. 4 is a block diagram illustrating drivers of the control unit in FIG. 3, in accordance with an embodiment of the invention.

FIG. 5 is a block diagram illustrating the control unit in FIG. 3, in accordance with an embodiment of the invention.

FIG. 6 illustrates a bottom view of the lighting apparatus in FIG. 1, in accordance with an embodiment of the invention.

FIG. 7 is a block diagram illustrating multiple lighting apparatuses arranged in a parallel lighting circuit, in accordance with an embodiment of the invention.

FIG. 8 is a block diagram illustrating multiple lighting apparatuses linked in a daisy-chain lighting circuit, in accordance with an embodiment of the invention.

FIG. 9 illustrates a side view of the lighting apparatus, in accordance with an embodiment of the invention.

FIG. 10 illustrates an alternate side view of the lighting apparatus, in accordance with an embodiment of the invention.

FIG. 11 illustrates a side perspective view of the lighting apparatus, wherein one lighting component is positioned in a forward-looking position, in accordance with an embodiment of the invention.

FIG. 12 illustrates a side perspective view of the lighting apparatus, wherein all lighting components are aligned, in accordance with an embodiment of the invention.

FIG. 13 illustrates a front view of the lighting apparatus, wherein one lighting component is positioned directly opposite the other lighting component, in accordance with an embodiment of the invention.

FIG. 14 illustrates a rear view of the lighting apparatus in FIG. 13, in accordance with an embodiment of the invention.

FIG. 15 illustrates a top view of the lighting apparatus in FIG. 13, in accordance with an embodiment of the invention.

FIG. 16 illustrates a top view of the lighting apparatus, wherein the lighting components 8 are panned clockwise, in accordance with an embodiment of the invention.

FIG. 17 illustrates a top view of the lighting apparatus, wherein the lighting components 8 are panned counter-clockwise, in accordance with an embodiment of the invention.

### DETAILED DESCRIPTION

The present invention relates generally to a lighting apparatus, and in particular, to a rotatable dual beam lighting apparatus. One embodiment provides a lighting apparatus comprising multiple individually rotatable lighting components, an actuator for rotating one or more of the lighting components, and a control unit for controlling the actuator and the lighting components. Each lighting component comprises one or more lighting elements. The control unit is configured to operate each lighting component independently. In one embodiment, the control unit is further configured to operate each lighting component in coordination with another lighting component.

The actuator is configured to pan the lighting components, and tilt one or more of the lighting components in the same direction or in different directions. In one embodiment, the actuator is configured to pan the lighting components about a substantially five hundred forty degree angle about a vertical axis. In one embodiment, the actuator is configured to tilt a lighting component about a substantially two hundred and seventy degree angle about a horizontal axis.

The control unit comprises a plurality of drivers. The drivers include at least one lighting driver for selectively controlling lighting effects of at least one of the lighting components, and an actuator driver for controlling movement of the actuator.

In one embodiment, the lighting apparatus further comprises an input/output interface board comprising a power socket for receiving power, a data input socket for receiving data control signals, and a data output socket for transmitting data control signals. The control unit controls the actuator and the lighting components based on the data control signals received. In one embodiment, the data input socket receives data control signals from a controller. In one embodiment, the controller is a Digital Multiplex (DMX) controller, and the received data control signals include DMX data instructions.

In one embodiment, the lighting apparatus further comprises a user interface board comprising a display screen and a plurality of manual control buttons. A user utilizes the display screen and the buttons to control the lighting effects of the lighting components and the movement of the actuator.

In one embodiment, the lighting apparatus further comprises a wireless module for wirelessly receiving data control signals including DMX data instructions from a wireless controller.

Another embodiment provides a lighting system comprising multiple lighting apparatuses and a controller for selectively providing data control signals to at least one of the lighting apparatuses. Each lighting apparatus comprises multiple individually rotatable lighting components, an actuator for rotating one or more of the lighting components, and a control unit for controlling the actuator and the lighting components based on data control signals. Each lighting component comprises one or more lighting elements. Each control unit of each lighting apparatus is configured to operate each lighting component of the lighting apparatus independently.

Another embodiment provides a method comprising providing data control signals to a lighting apparatus, and controlling the lighting apparatus based on the data control signals. The lighting apparatus comprises multiple individually rotatable lighting components, an actuator for rotating one or more of the lighting components, and a control unit for controlling the actuator and the lighting components based on the data control signals. Each lighting component comprises one or more lighting elements. The control unit is configured to operate each lighting component independently.

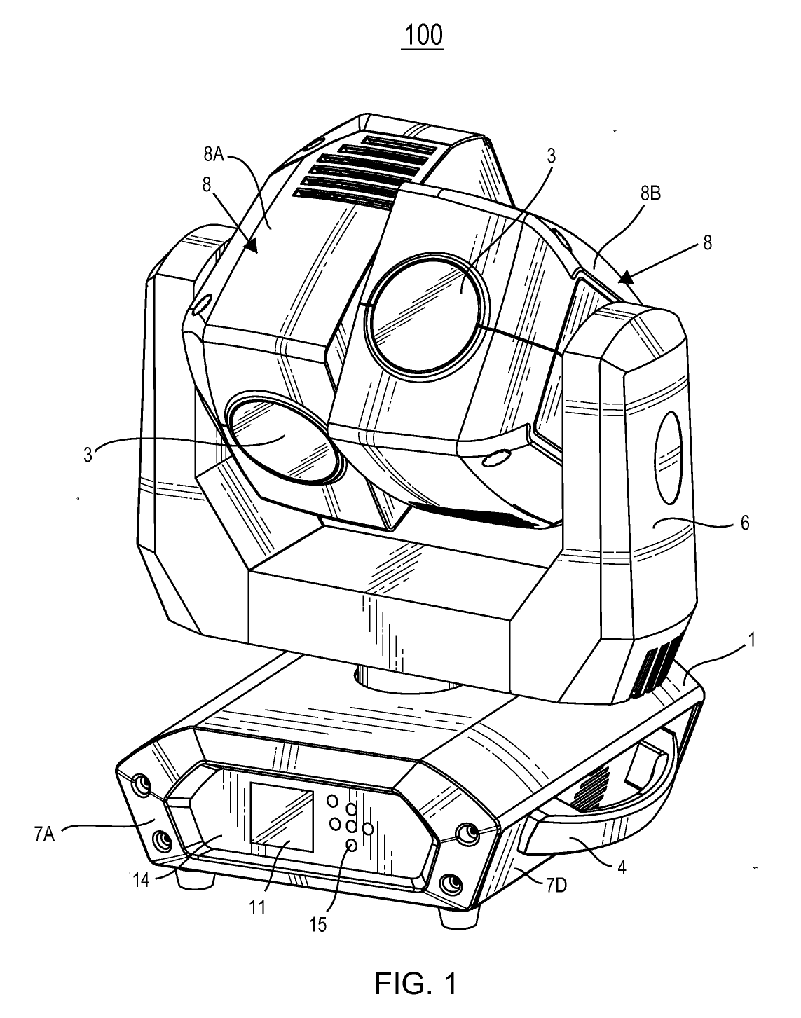

FIG. 1 illustrates a front perspective view of a rotatable dual beam lighting apparatus 100, in accordance with an embodiment of the invention. The lighting apparatus 100 comprises a plurality of lighting components 8, a support mechanism 6 for rotating the lighting components 8, and a controller unit 1 for controlling the lighting components 8 and the support mechanism 6.

As shown in FIG. 1, the lighting components 8 include a first lighting component 8A and a second lighting component 8B. As described in detail later herein, each lighting component 8 may operate either independently or in coordination with another lighting component 8.

Each lighting component 8 comprises a lighting source 3. A lighting source includes one or more lighting emitting elements, such as semiconductor light emitting diodes (LEDs), organic LEDs, light bulbs, lasers, or liquid crystal display (LCD) panels.

Each lighting component 8 is pivotally coupled to the support mechanism 6. The support mechanism 6 is shaped to support the lighting components 8. In one embodiment, the support mechanism 6 is U-shaped.

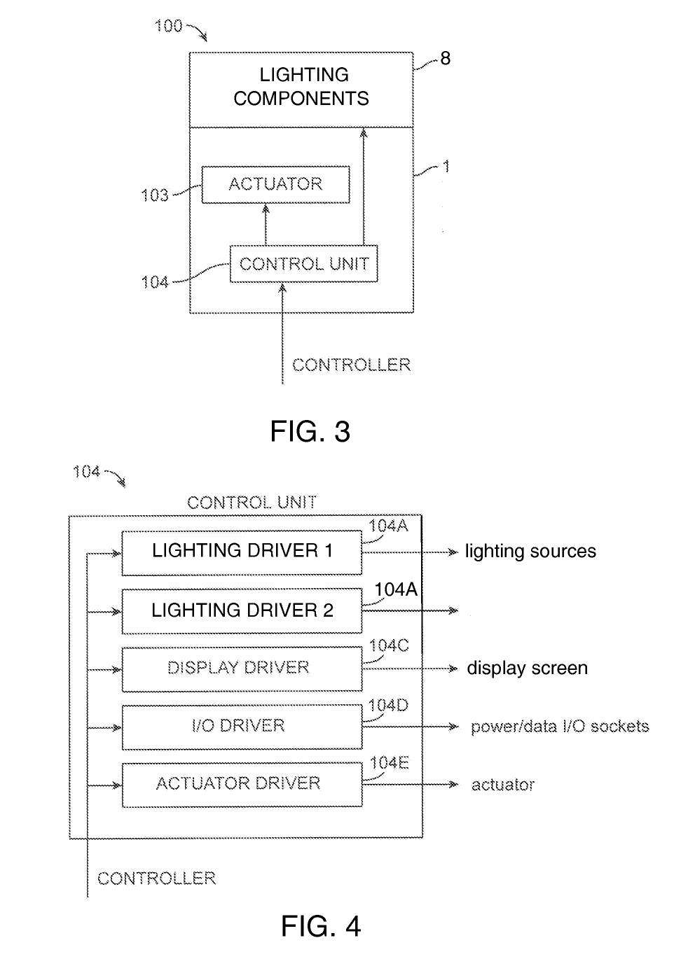

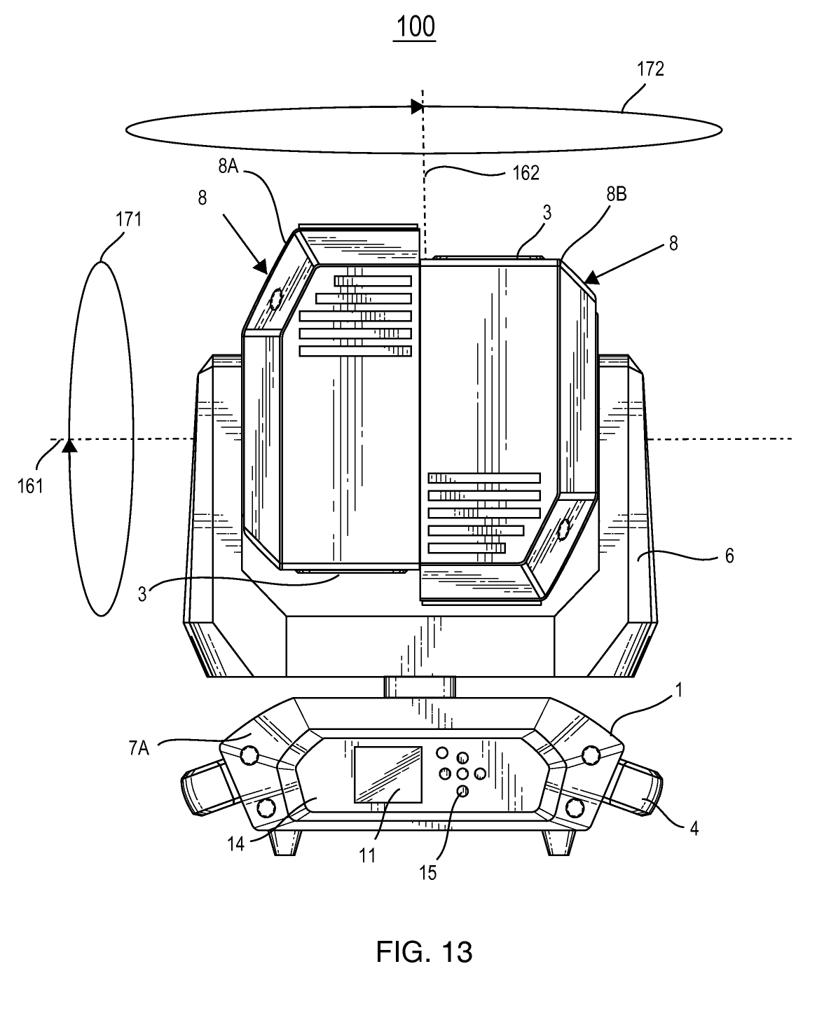

The controller unit 1 comprises an actuator 103 (FIG. 3) and a control unit 104 (FIG. 3). As described in detail later herein, the actuator 103 moves/rotates the support mechanism 6 and the lighting components 8. The actuator 103 may rotate the lighting components 8 in a pan direction 172 (FIG. 13) or a tilt direction 171 (FIG. 13). The control unit 104 includes circuits/logic for controlling the actuator 103 and each lighting source 3 of each lighting component 8.

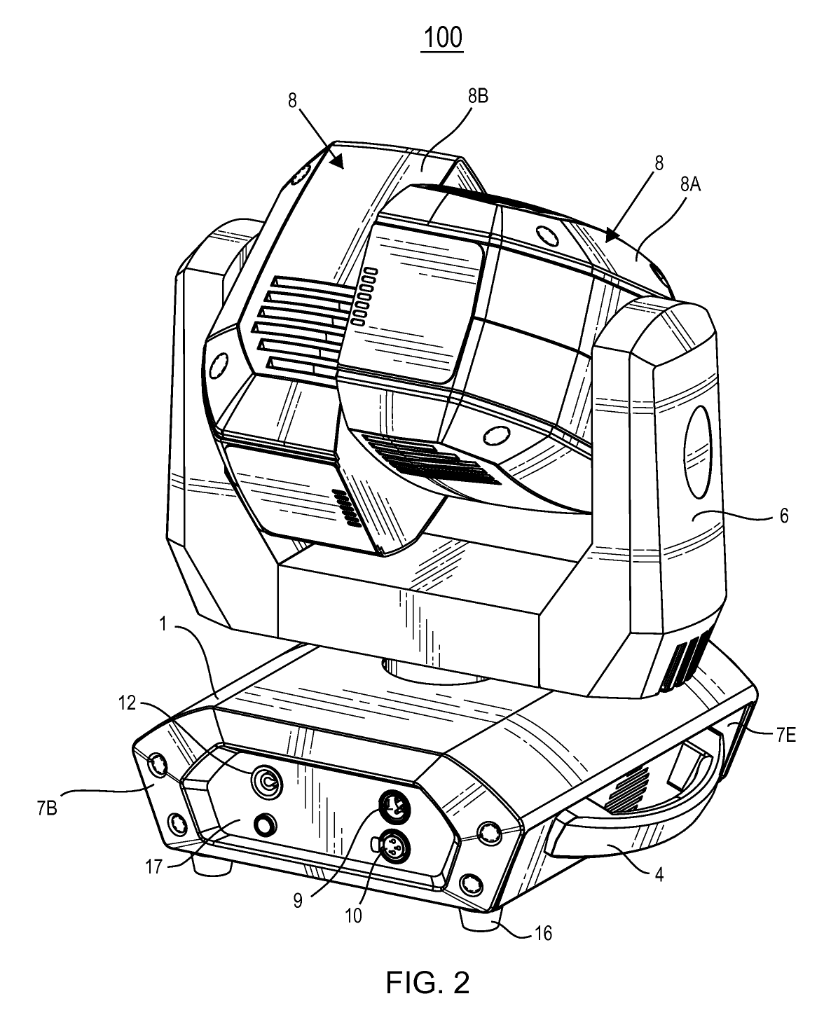

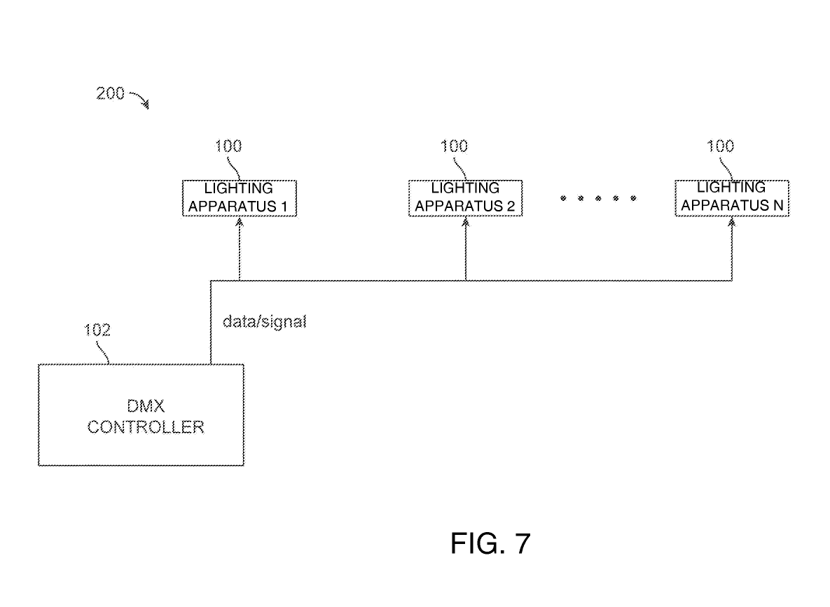

The controller unit 1 has a plurality of side walls, such as a front side wall 7A, a rear side wall 7B (FIG. 2), a bottom side wall 7C (FIG. 6), a right side wall 7D, and a left side wall 7E (FIG. 2). The front side wall 7A is substantially parallel to the rear side wall 7B. The right side wall 7D is substantially parallel to the left side wall 7E. The bottom side wall 7C extends transversely between the side walls 7A, 7B, 7C and 7D. A side wall may include a carrying handle 4. For example, as shown in FIGS. 1 and 2, a first carrying handle 4 is disposed on the right side wall 7D, and a second carrying handle 14 is disposed on the left side wall 7E.

The controller unit further comprises a user interface board 14. The user interface board 14 may be disposed on any side wall of the controller unit 1, such as the front side wall 7A as shown in FIG. 1. The user interface board 14 includes a display screen 11 (e.g., an LCD display screen) and multiple manual control buttons 15. A user may utilize the control buttons 15 to display and control different operating functions of the lighting apparatus 100.

FIG. 2 illustrates a rear perspective view of the lighting apparatus 100 in FIG. 1, in accordance with an embodiment of the invention. The controller unit further comprises an input/output (I/O) interface board 17. The I/O interface board 17 may be disposed on any side wall of the controller unit 1, such as the rear side wall 7B as shown in FIG. 2. The I/O interface board 17 includes multiple electrical connectors/sockets to interface with data and power inputs/outputs.

In one embodiment, the I/O interface board 17 includes a power socket 12 for receiving power from a power supply, a data input socket 9 for receiving data control signals, and a data output socket 10 for transmitting data control signals.

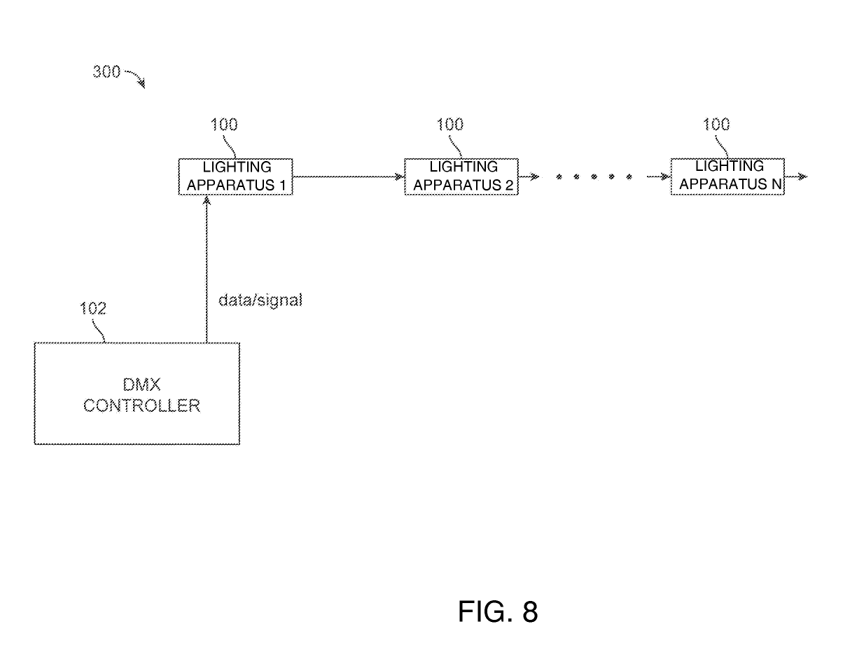

Digital multiplex (DMX) is a communications protocol allowing different devices to be linked together and operated from a single controller, provided that the devices and the controller are DMX compliant. In one embodiment, the data input socket 9 is a DMX input socket 9 (e.g., a 3-pin DMX input connector or a 5-pin DMX input connector), and the data output socket 10 is a DMX output socket 10 (e.g., a 3-pin DMX output connector or a 5-pin DMX output connector). DMX signals received via the DMX input socket 9 comprise DMX data instructions from a DMX compliant controller 102 (FIG. 8), such as a DMX512 controller. The lighting apparatus 100 may have a DMX address (e.g., a DMX512 address) used to route DMX signals thereto from the controller 102. The DMX output socket 10 transmits DMX signals to another DMX compliant device such as another lighting apparatus 100.

FIG. 3 is a block diagram illustrating components of the lighting apparatus 100 in FIG. 1, in accordance with an embodiment of the invention. As stated above, the control unit 104 controls the actuator 103 and each lighting source 3 of each lighting component 8. The control unit 104 may control the actuator 103 and each lighting source 3 of each lighting component 8 based on data control signals received via the data input socket 9. The data control signals received may be from a controller 102, such as a DMX512 controller.

FIG. 4 is a block diagram illustrating drivers of the control unit 104 in FIG. 3, in accordance with an embodiment of the invention. The control unit 104 comprises a plurality of drivers, such as at least one lighting driver 104A, a display driver 104C, a power/data input/output (I/O) driver 104D, and an actuator driver 104E.

As stated above, each lighting component 8 may operate either independently or in coordination with another lighting component 8. In one embodiment, the control unit 104 includes a corresponding lighting driver 104A for each lighting component 8. For example, as shown in FIG. 4, the control unit 104 includes a first lighting driver 104A (LIGHTING DRIVER 1) for the first lighting component 8A, and a second lighting driver 104A (LIGHTING DRIVER 2) for the second lighting component 8B. Each lighting driver 104A controls the lighting effects of each lighting source 3 of a corresponding lighting component 8. For example, a lighting driver 104A can selectively turn on or turn off each lighting source 3 of a corresponding lighting component 8. The lighting driver 104A can also selectively adjust the color temperature or brightness of each lighting source 3 of a corresponding lighting component 8.

The display driver 104C controls the display screen 11 and the manual control buttons 15 of the user interface board 14. The power/data I/O driver 104D controls the power socket 12, the data input socket 9, and the data output socket 10 of the I/O interface board 17.

The actuator driver 104E controls movement of the actuator 103. The actuator driver 104E controls how the actuator 103 rotates the support mechanism 6 and each lighting component 8 to a desired position. In one embodiment, the actuator 103 may pan the support mechanism 6 and the lighting components 8 to a desired orientation. The actuator 103 may also tilt one or more of the lighting components 8 to a desired orientation. Specifically, each lighting component 8 may be independently actuated by the actuator 103 to tilt to a desired orientation. For example, as shown in FIG. 1, the first lighting component 8A is tilted to a partially downward-looking position, and the second lighting component 8B is titled to a partially upward-looking position. The actuator driver 104E also controls the speed at which the actuator 103 pans and/or tilts.

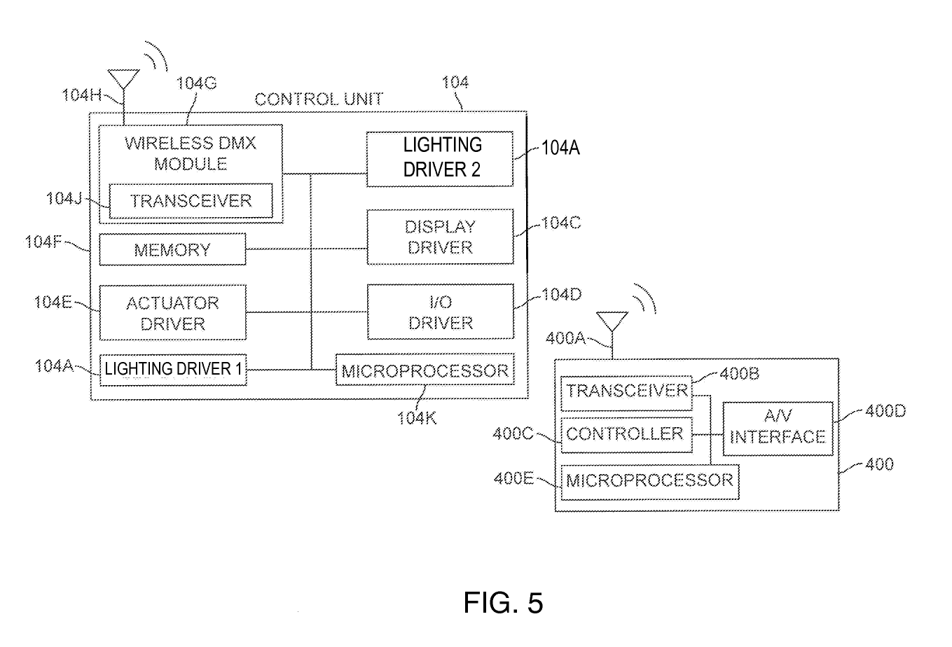

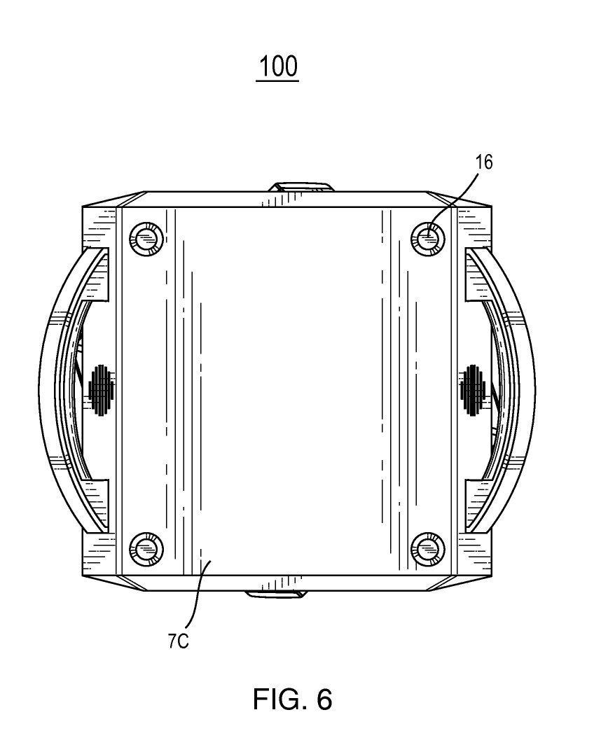

FIG. 5 is a block diagram illustrating the control unit 104 in FIG. 3, in accordance with an embodiment of the invention. In addition to drivers, the control unit 104 may further comprise a wireless module 104G, a memory unit 104F, and a microprocessor 104K.

In one embodiment, the operating functions of the lighting apparatus 100 may also be wirelessly controlled using a remote wireless controller 400. The wireless module 104G is configured to wirelessly communicate/exchange information (e.g., data control signals) with the wireless controller 400. In one embodiment, the wireless module 104G operates on one or more radio frequencies. The wireless module 104G includes an antenna 104H and a wireless transceiver 104J. The antenna 104H and the transceiver 104J are configured to wirelessly receive radio frequency (RF) signals from, and wirelessly transmit RF signals to, a wireless transceiver 400B of the wireless controller 400. The RF signals received include data control signals such as DMX signals. In another embodiment, the antenna 104H and the transceiver 104J wirelessly exchange information (e.g., data control signals) with the wireless controller 400 using infrared (I/R) waves.

In one embodiment, the controller 400 is a DMX controller, and the wireless module 104G wirelessly receives DMX data signals from the controller 400.

The microprocessor 104K is configured to process the data control signals received. The memory unit 104F maintains information, such as a DMX address of the lighting apparatus 100.

As shown in FIG. 5, the controller 400 comprises an antenna 400A, a wireless transceiver 400B, a controller 400C, a microprocessor 400E, and an A/V interface 400D. The A/V interface 400D of the controller 400 may comprise a graphic display, and alphanumeric and directional keypads that a user can use to enter input commands. The A/V interface 400D may comprise other types of electronic or manual data input means. The microprocessor 400E of the controller 400 is configured to process the input commands entered and generate the appropriate data control signals. The controller 400C of the controller 400 is configured to generate RF signals including the data controls signals generated.

The antenna 400A and the transceiver 400B of the controller 400 are configured to wirelessly communicate/exchange information (e.g., data control signals) with the wireless module 104G of the control unit 104. In one embodiment, the antenna 400A and the transceiver 400B operate on one or more radio frequencies. The antenna 400A and the transceiver 400B wirelessly receive RF signals from, and wirelessly transmit RF signals to, the wireless module 104G. In another embodiment, the antenna 400A and the transceiver 400B wirelessly exchange information (e.g., data control signals) with the wireless module 104G using infrared (I/R) waves.

The data control signals (e.g., DMX signals) received via the data input socket 9 or the wireless module 104G are delivered to the drivers of the control unit 104 for controlling different operating functions of the lighting apparatus 100. These operating functions may include setting and displaying a DMX address for the lighting apparatus 100, moving the actuator 103 to pan and/or tilt one or more lighting components 8, setting the speed at which the lighting components 8 are panned and/or tilted, or controlling the lighting effects of the lighting sources 3 such as selectively lighting the lighting sources 3 or selectively adjusting the color temperature and/or brightness of the lighting sources 3.

FIG. 6 illustrates a bottom view of the lighting apparatus 100 in FIG. 1, in accordance with an embodiment of the invention. The bottom side wall 7C of the controller unit 1 includes a plurality of support members 16. The support members 16 are distributed evenly on the bottom side wall 7C to stabilize and support the lighting apparatus 100 when the lighting apparatus 100 is set upright on a flat supporting surface, such as a table or ground.

The lighting apparatus 100 may be used as a stand alone, in multiples such as in a parallel lighting circuit 200 (FIG. 7), or linked in a master/slave configuration such as a daisy-chain (i.e., serial) lighting circuit 300 (FIG. 8). In the daisy-chain circuit 300, data control signals (e.g., DMX signals) are sent as serial data that travel from one lighting apparatus 100 to another lighting apparatus 100 via the I/O sockets 9, 10 of each lighting apparatus 100. For example, the input socket 9 receives master/slave DMX signals and the output socket 10 transmits master/slave DMX signals to the next lighting apparatus 100 in the master/slave circuit 300. Each lighting apparatus 100 may have a unique DMX address used to route DMX signals thereto.

FIG. 7 is a block diagram illustrating multiple lighting apparatuses 100 arranged in a parallel lighting circuit 200, in accordance with an embodiment of the invention. The circuit 200 comprises multiple lighting apparatuses 100, such as a first lighting apparatus 100 (LIGHTING APPARATUS 1), a second lighting apparatus 100 (LIGHTING APPARATUS 2), . . . , and an N^{th} lighting apparatus 100 (LIGHTING APPARATUS N). The circuit 200 is controlled by a controller 102, such as a DMX compliant controller. Each lighting apparatus 100 receives data control signals (e.g., DMX signals) from the controller 102 via the data input socket 9.

Each lighting apparatus 100 in the circuit 200 may also be wirelessly controlled by a wireless controller 400. As described above and illustrated in FIG. 5, a wireless module 104G of each lighting apparatus 100 can wirelessly receive data control signals (e.g., DMX signals) from with a wireless controller 400.

In one embodiment, the controller 102 and/or the wireless controller 400 may selectively send data control signals to a lighting apparatus 100 of the circuit 200. For example, the controller 102 and/or the wireless controller 400 may selectively route a first set of data control signals to a first DMX address corresponding to the first lighting apparatus 100 (LIGHTING APPARATUS 1), and route a different set of data control signals to a second DMX address corresponding to the second lighting apparatus 100 (LIGHTING APPARATUS 2). Therefore, a lighting apparatus 100 of the circuit 200 may be operated differently from other lighting apparatuses 100 of the circuit 200 based on a corresponding set of data control signals from the controller 102 and/or the wireless controller 400.

FIG. 8 is a block diagram illustrating multiple lighting apparatuses 100 linked in a daisy-chain lighting circuit 300, in accordance with an embodiment of the invention. The circuit 300 comprises multiple lighting apparatuses 100, such as a first lighting apparatus 100 (LIGHTING APPARATUS 1), a second lighting apparatus 100 (LIGHTING APPARATUS 2), . . . , and an N^{th} lighting apparatus 100 (LIGHTING APPARATUS N). The circuit 300 is controlled by a controller 102, such as a DMX compliant controller. In the daisy-chain circuit 300, data control signals (e.g., DMX signals) are sent as serial data that travel from one lighting apparatus 100 to another lighting apparatus 100 via the data I/O sockets 9, 10 of each lighting apparatus 100. Specifically, the data input socket 9 receives master/slave data control signals and the data output socket 10 transmits master/slave data control signals to the next lighting apparatus 100 in the master/slave circuit 300. For example, as shown in FIG. 8, a first lighting apparatus 100 (LIGHTING APPARATUS 1) receives data control signals from the controller 102. The first lighting apparatus 100 then transmits data control signals to a second lighting apparatus 100 (LIGHTING APPARATUS 2).

Each lighting apparatus 100 in the circuit 300 may also be wirelessly controlled by a wireless controller 400. As described above and illustrated in FIG. 5, a wireless module 104G of each lighting apparatus 100 can wirelessly receive data control signals (e.g., DMX signals) from with a wireless controller 400.

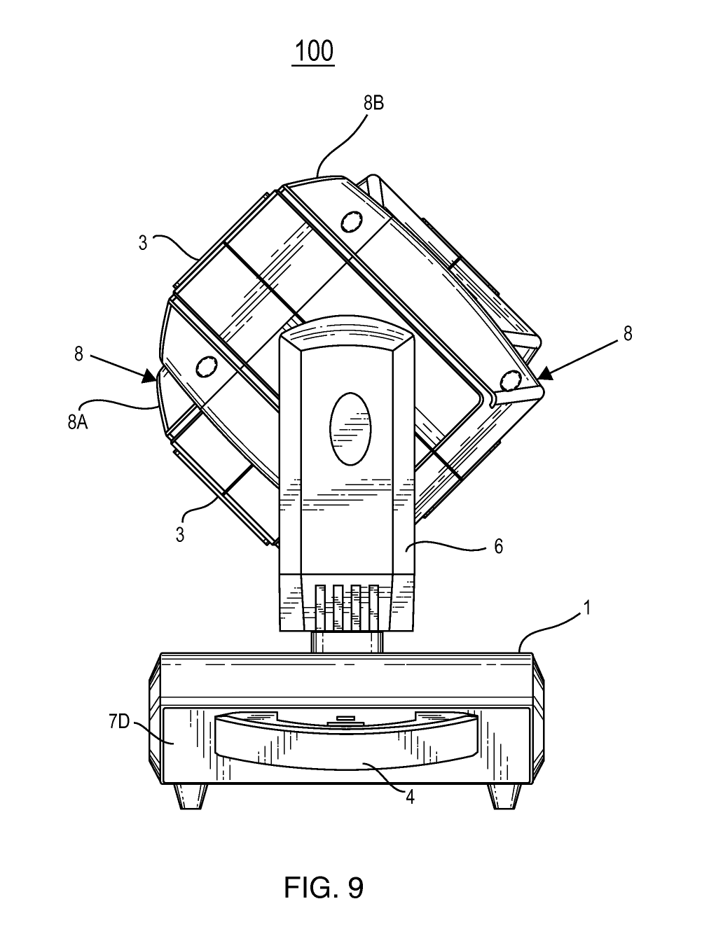

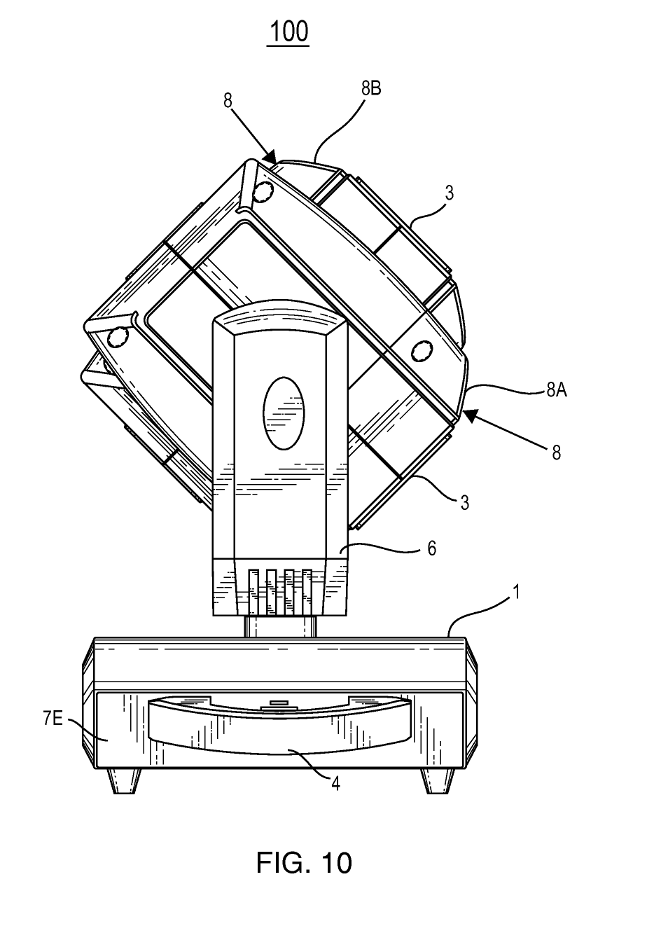

FIG. 9 illustrates a side view of the lighting apparatus 100, in accordance with an embodiment of the invention. FIG. 10 illustrates an alternate side view of the lighting apparatus 100, in accordance with an embodiment of the invention. As shown in FIGS. 9-10, the first lighting component 8A is positioned in a partially downward-looking position, and the second lighting component 8B is positioned in a partially upward-looking position. The second lighting component 8B is rotated about a substantially ninety degree angle relative to the first lighting component 8A. The actuator 103 can tilt each lighting component 8 from a forward-looking position to a downward-looking/upward-looking position.

The actuator 103 may rotate the lighting components 8 in a pan direction 172 (FIG. 13) or a tilt direction 171 (FIG. 13). In one embodiment, the actuator 103 of the lighting apparatus 100 can pan the lighting components 8 in about a substantially five hundred forty degree angle)(540° about a vertical axis 162 (FIG. 13). For example, the actuator 103 can pan a lighting component 8 from a forward-looking position to a backward-looking position. The actuator 103 of the lighting apparatus 100 can also tilt each lighting component 8 about a substantially two hundred and seventy degree angle)(270° about a horizontal axis 161 (FIG. 13). For example, the actuator 103 can tilt a lighting component 8 from a forward-looking position to a downward-looking/upward-looking position. Each lighting component 8 may be individually actuated by the actuator 103.

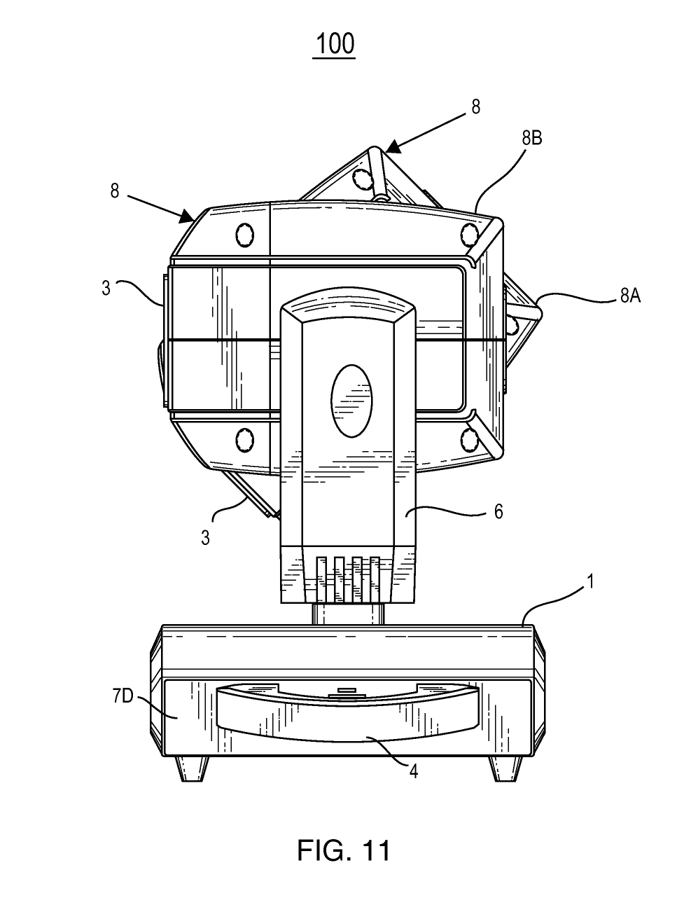

FIGS. 11-17 illustrate an example of the range of panning and/or tilting motion of each lighting component 8 of the lighting apparatus 100, in accordance with an embodiment of the invention.

FIG. 11 illustrates a side perspective view of the lighting apparatus 100, wherein one lighting component 8 is positioned in a forward-looking position, in accordance with an embodiment of the invention. Specifically, the second lighting component 8B is positioned in a forward-looking position. The first lighting component 8A is positioned in a partially downward-looking position. The second lighting component 8B is rotated about a substantially forty-five degree angle relative to the first lighting component 8A.

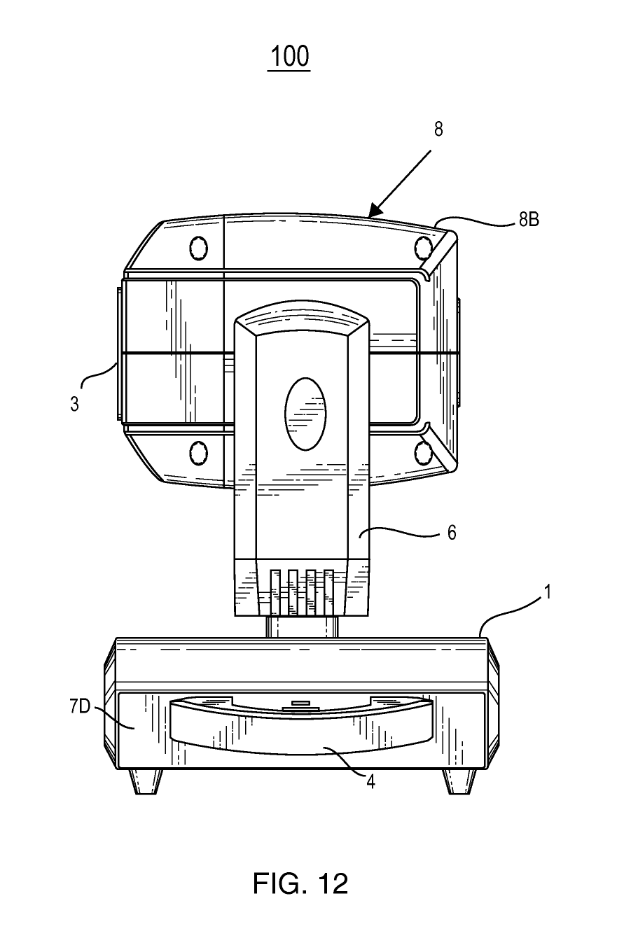

FIG. 12 illustrates a side perspective view of the lighting apparatus 100, wherein all lighting components 8 are aligned, in accordance with an embodiment of the invention. Specifically, the first lighting component 8A (not shown for clarity) and the second lighting component 8B are both positioned in a forward-looking position.

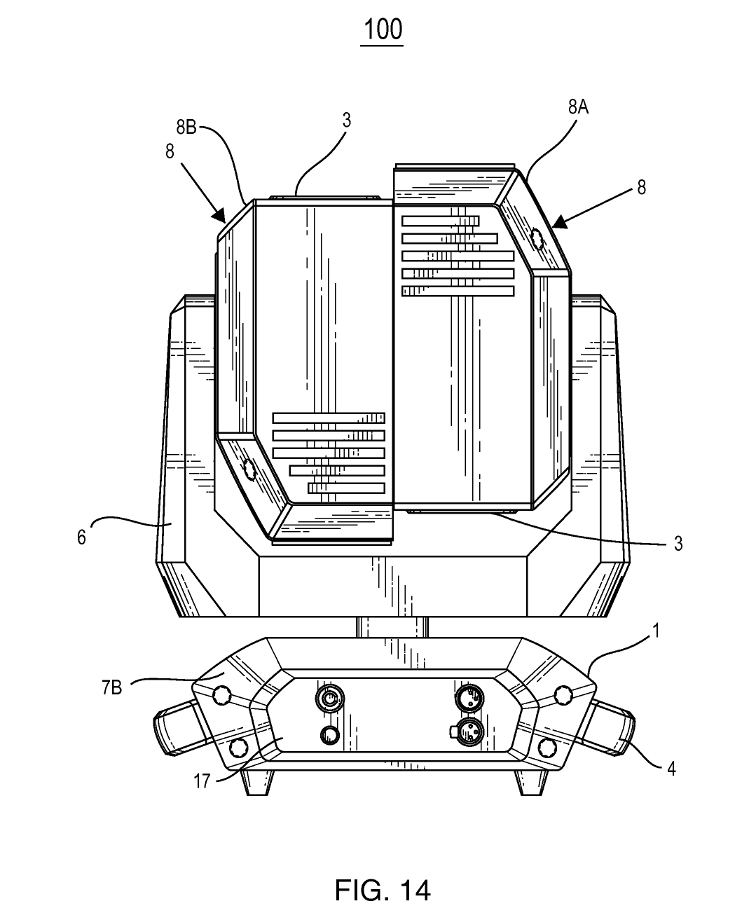

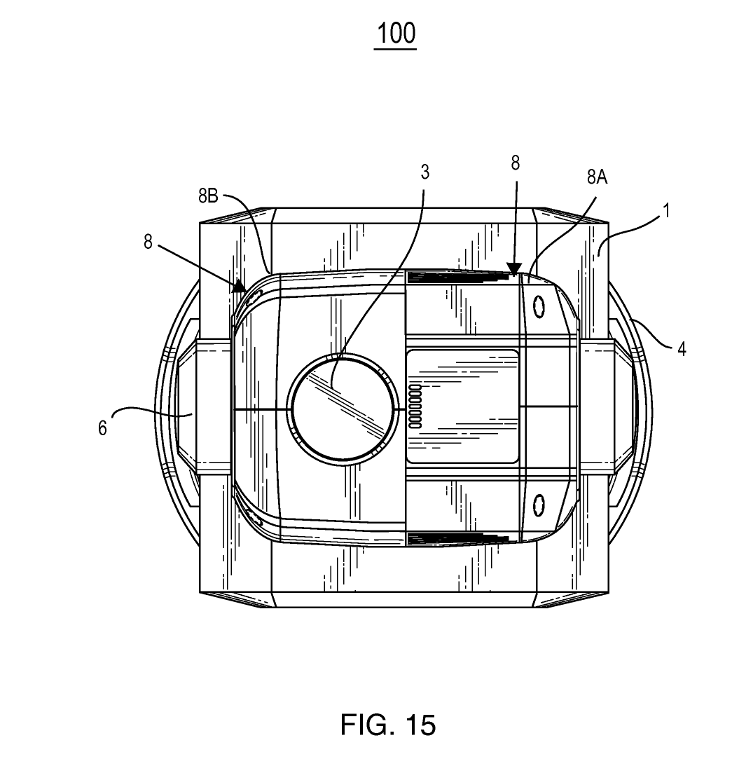

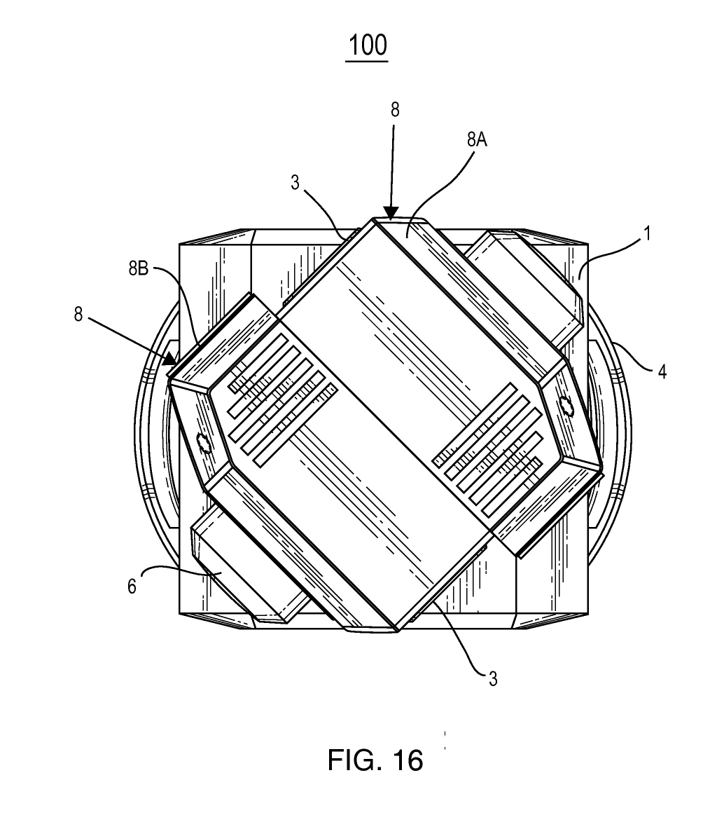

FIG. 13 illustrates a front view of the lighting apparatus 100, wherein one lighting component 8 is positioned directly opposite the other lighting component 8, in accordance with an embodiment of the invention. FIG. 14 illustrates a rear view of the lighting apparatus 100 in FIG. 13, in accordance with an embodiment of the invention. FIG. 15 illustrates a top view of the lighting apparatus 100 in FIG. 13, in accordance with an embodiment of the invention. As shown in FIGS. 13-15, the second lighting component 8B is positioned in an upward-looking position, and the first lighting component 8A is positioned in a downward-looking position. The second lighting component 8B is rotated about a substantially one-hundred and eighty degree angle relative to the first lighting component 8A.

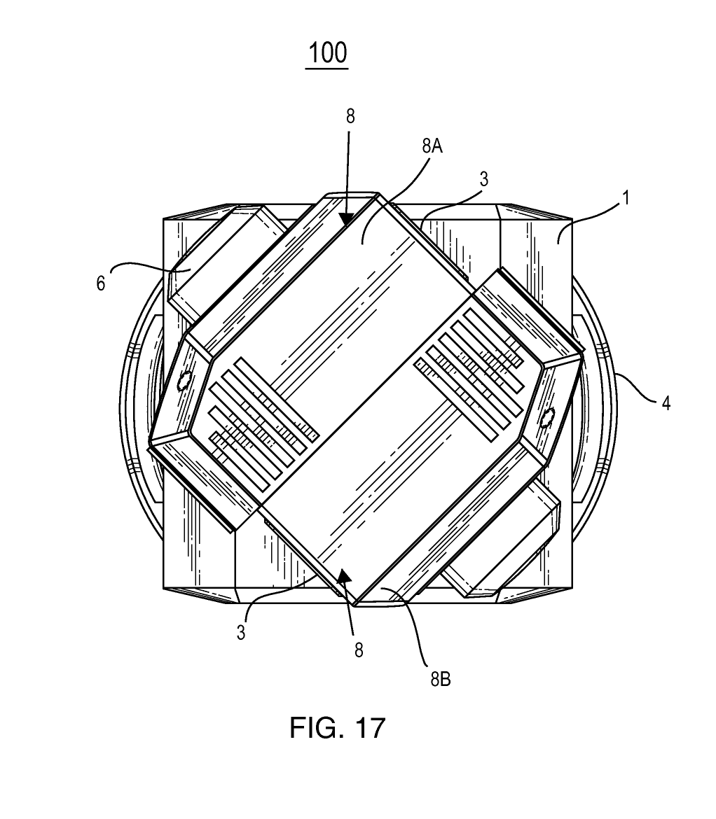

FIG. 16 illustrates a top view of the lighting apparatus 100, wherein the lighting components 8 are panned clockwise, in accordance with an embodiment of the invention. As shown in FIG. 16, the first lighting component 8A and the second lighting component 8B are positioned in a forward-looking position and a backward-looking position, respectively.

FIG. 17 illustrates a top view of the lighting apparatus 100, wherein the lighting components 8 are panned counter-clockwise, in accordance with an embodiment of the invention. As shown in FIG. 17, the first lighting component 8A and the second lighting component 8B are positioned in a forward-looking position and a backward-looking position, respectively.

The present invention has been described in considerable detail with reference to certain preferred versions thereof; however, other versions are possible. The above description is made for the purpose of illustrating the general principles of the present invention and is not meant to limit the inventive concepts claimed herein. Further, particular features described above can be used in combination with other described features in each of the various possible combinations and permutations. Unless otherwise specifically defined herein, all terms should be given their broadest possible interpretation including meanings implied from the specification as well as meanings understood by those skilled in the art and/or as defined in dictionaries, treatises, etc. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A lighting apparatus, comprising:
multiple individually rotatable lighting components, wherein each lighting component comprises one or more lighting elements;
an actuator for rotating one or more of said multiple lighting components; and
a control unit for controlling the actuator and said multiple lighting components;
wherein the control unit is configured to operate each lighting component independently.

2. The lighting apparatus of claim 1, wherein the control unit is further configured to operate each lighting component in coordination with another lighting component.

3. The lighting apparatus of claim 1, wherein the actuator is configured to:
pan said multiple lighting components; and
tilt one or more of said multiple lighting components.

4. The lighting apparatus of claim 3, wherein each lighting component is tilted in a direction different from another lighting component.

5. The lighting apparatus of claim 1, wherein:
the control unit comprises a plurality of drivers; and
said plurality of drivers include:
at least one lighting driver for selectively controlling lighting effects of at least one of said multiple lighting components; and
an actuator driver for controlling movement of the actuator.

6. The lighting apparatus of claim 1, further comprising:
an input/output interface board comprising:
a power socket for receiving power;
a data input socket for receiving data control signals; and
a data output socket for transmitting data control signals.

7. The lighting apparatus of claim 6, wherein the control unit controls
the actuator and said multiple lighting components based on the data control signals received.

8. The lighting apparatus of claim 6, wherein the data input socket receives data control signals from a controller.

9. The lighting apparatus of claim 8, wherein:
the controller is a Digital Multiplex (DMX) controller; and
the received data control signals include DMX data instructions.

10. The lighting apparatus of claim 1, further comprising:
a user interface board comprising:
a display screen; and
a plurality of manual control buttons;
wherein a user utilizes the display screen and the buttons to control the lighting effects of said multiple lighting components and the movement of the actuator.

11. The lighting apparatus of claim 3, wherein:
the actuator is further configured to pan said multiple lighting components about a substantially five hundred forty degree angle about a vertical axis; and
the actuator is further configured to tilt a lighting component about a substantially two hundred and seventy degree angle about a horizontal axis.

12. The lighting apparatus of claim 6, further comprising:
a wireless module for wirelessly receiving data control signals including DMX data instructions from a wireless controller.

13. A lighting system, comprising:
multiple lighting apparatuses; and
a controller for selectively providing data control signals to at least one of said multiple lighting apparatuses;
wherein each lighting apparatus comprises:
multiple individually rotatable lighting components, wherein each lighting component comprises one or more lighting elements;
an actuator for rotating one or more of said multiple lighting components; and
a control unit for controlling said actuator and said multiple lighting components based on data control signals, wherein said control unit is configured to operate each lighting component independently.

14. The lighting system of claim 13, wherein each control unit of each lighting apparatus is further configured to operate each lighting component of said lighting apparatus in coordination with another lighting component of said lighting apparatus.

15. The lighting system of claim 13, wherein each actuator of each lighting apparatus is further configured to:
pan said multiple lighting components of said lighting apparatus; and
tilt one or more of said multiple lighting components of said lighting apparatus.

16. The lighting system of claim 15, wherein each lighting component of a lighting apparatus is tilted in a direction different from another lighting component of said lighting apparatus.

17. The lighting system of claim 13, wherein:
each control unit of each lighting apparatus comprises a plurality of drivers, wherein said plurality of drivers include the following: at least one lighting driver for selectively controlling lighting effects of at least one of said multiple lighting components of said lighting apparatus, and an actuator driver for controlling movement of said actuator of said lighting apparatus; and
each control unit of each lighting apparatus controls said actuator and said multiple lighting components of said lighting apparatus based on data control signals for said lighting apparatus from the controller.

18. The lighting system of claim 13, wherein:
the controller is a wireless controller; and
each lighting apparatus further comprises a wireless module for wirelessly receiving data control signals from the controller.

19. A method, comprising:
providing data control signals to a lighting apparatus; and
controlling said lighting apparatus based on said data control signals;
wherein said lighting apparatus comprises:
multiple individually rotatable lighting components, wherein each lighting component comprises one or more lighting elements;
an actuator for rotating one or more of said multiple lighting components; and
a control unit for controlling the actuator and said multiple lighting components based on said data control signals, wherein the control unit is configured to operate each lighting component independently.

20. The method of claim 19, wherein the actuator is further configured to:
pan said multiple lighting components; and
tilt one or more of said multiple lighting components in the same direction or in different directions.
